(19) United States
(12) Patent Application Publication
(10) Pub. No.: US 2009/0244054 A1
(43) Pub. Date: Oct. 1, 2009

(54) DISPLAY DEVICE AND METHOD OF DRIVING THE SAME

(76) Inventors: Hyo-Jin Lee, Yongin-city (KR); Il-Han Lee, Yongin-city (KR); Yun-Tae Kim, Yongin-city (KR)

Correspondence Address: CHRISTIE, PARKER & HALE, LLP, PO BOX 7068, PASADENA, CA, 91109-7068, US

(21) Appl. No.: 12/416,798

(22) Filed: Apr. 1, 2009

(30) Foreign Application Priority Data
Apr. 1, 2008 (KR) 10-2008-0030323

(51) Int. Cl. G06F 3/038

(52) U.S. Cl. 345/213

(57) ABSTRACT

A display device and a method of driving the display device are provided. The display device includes a scan driver for transmitting scan signals to a plurality of scan lines, a data driver for transmitting data signals to a plurality of data lines, and a signal controller for controlling the transmissions of the scan driver and the data driver. The scan driver and the data driver are configured to begin operating in response to a reset signal. The signal controller is configured to detect the reset signal, to determine whether the detected reset signal is a normal reset signal or an abnormal reset signal applied after an on time at which power is supplied to the scan driver and the data driver, and to apply a normal reset signal when the detected reset signal is determined to be an abnormal reset signal.

### CROSS-REFERENCE TO RELATED APPLICATION

This application claims priority to and the benefit of Korean Patent Application No. 10-2008-0030323 filed in the Korean Intellectual Property Office on Apr. 1, 2008, the entire content of which is incorporated herein by reference.

### BACKGROUND OF THE INVENTION

1. Field of the Invention

The present invention relates to a display device and a method of driving the same.

2. Description of the Related Art

When a display device is turned on and starts to operate, a reset signal is input to a driver that controls the operation of the display device. The reset signal is a starting signal that initializes the driver in order to operate the display device.

The reset signal has a predetermined waveform after power is supplied to the display device. The driver starts to operate when sensing the reset signal. In some instances, the reset signal may not have the predetermined waveform or the driver may not recognize the reset signal. Then, the driver is not started normally, and thus the display device may operate abnormally. Specifically, when the display device operates abnormally, an abnormal driving voltage and/or an abnormal driving command to control the driver are provided in the initial operation of the driver. An abnormal driving voltage and an abnormal driving command cause abnormally low luminance or abnormally high luminance of images, gray level distortion of images and abnormal colors in images.

### SUMMARY OF THE INVENTION

The present invention provides a display device and a method of driving the same which detects whether a reset signal is abnormal and generating a normal reset signal to initialize a driver.

The present invention provides a display device and a method of driving the same for preventing abnormally low luminance or abnormally high luminance of images, gray level distortion of images, and abnormal colors in images caused by an abnormal reset signal.

An exemplary embodiment of the present invention provides a display device including: a scan driver for transmitting scan signals to a plurality of scan lines; a data driver for transmitting data signals to a plurality of data lines; and a signal controller for controlling the transmissions of the scan driver and the data driver, wherein the scan driver and the data driver are configured to begin operating in response to a reset signal, and wherein the signal controller is configured to detect the reset signal, to determine whether the detected reset signal is a normal reset signal or an abnormal reset signal applied after an on time at which power is supplied to the scan driver and the data driver, and to apply a normal reset signal when the detected reset signal is determined to be an abnormal reset signal.

The scan driver and the data driver may be configured to begin operating when a voltage of the reset signal is adjusted from a first level to a second level after the on time.

The signal controller may be configured to determine that the detected reset signal is an abnormal reset signal when the detected reset signal corresponds to the first level at the on time and the voltage of the reset signal is not adjusted after the on time, and to apply a normal reset signal by adjusting the voltage of the reset signal to the second level.

The signal controller may be configured to determine that the detected reset signal is an abnormal reset signal when the detected reset signal corresponds to the second level at the on time, and to apply a normal reset signal by adjusting the voltage of the reset signal to the first level, and then adjusting the voltage of the reset signal back to the second level.

The signal controller may be configured to determine that the detected reset signal is an abnormal reset signal when the reset signal is adjusted from the first level to the second level at or before the on time, and to apply a normal reset signal by adjusting the voltage of the reset signal to the first level, and then adjusting the voltage of the reset signal back to the second level.

The first level may correspond to a low level and the second level may correspond to a high level.

The display device may further include: a plurality of pixels arranged in a matrix, each of the plurality of pixels including a switching transistor and a driving transistor; a driving voltage line for transmitting a driving voltage to the driving transistors of the plurality of pixels; a voltage generator for applying the driving voltage to the driving voltage line; and a gray voltage generator for generating a gray voltage, wherein the data driver is configured to convert an input video signal to a data voltage in accordance with the gray voltage and to apply the data voltage to the data lines.

Each of the plurality of pixels may further include a capacitor coupled between an input terminal and a control terminal of the driving transistor, wherein the scan signals may be transmitted to a control terminal of the switching transistor, and wherein an output terminal of the switching transistor may be coupled to the control terminal of the driving transistor, an input terminal of the switching transistor may be coupled to a corresponding one of the data lines, and an output terminal of the driving transistor may be coupled to a light emitting element.

The light emitting element may be an organic light emitting diode.

Another exemplary embodiment of the present invention provides a method of driving a display device including at least one driver configured to begin operating after power is supplied in accordance with a reset signal, the method including: detecting the reset signal; determining whether the detected reset signal is a normal reset signal or an abnormal reset signal after the power is first supplied; and applying a normal reset signal when the detected reset signal is determined to be an abnormal reset signal.

A normal reset signal may be detected when a voltage of the reset signal is adjusted from a first level to a second level after the power is first supplied.

An abnormal reset signal may be detected when the voltage of the reset signal corresponds to the first level when the power is first supplied and the voltage of the reset signal is not adjusted after the power is first supplied, and wherein applying a normal reset signal may include adjusting the voltage of the reset signal to the second level.

An abnormal reset signal may be detected when the voltage of the reset signal corresponds to the second level when the power is first supplied, and wherein applying a normal reset signal may include adjusting the voltage of the reset signal to the first level, and then adjusting the voltage of the reset signal back to the second level.

An abnormal reset signal may be detected when the voltage of the reset signal is adjusted from the first level to the second level at or before a time when the power is first supplied, and wherein applying a normal reset signal may include adjusting the voltage of the reset signal to the first level, and then adjusting the voltage of the reset signal back to the second level.

As described above, the present invention may detect whether a reset signal is abnormal and generates a normal reset signal to initialize the driver. Accordingly, it is possible to prevent abnormally low luminance or abnormally high luminance of images, gray level distortion of images, and abnormal colors in images caused by an abnormal reset signal.

### BRIEF DESCRIPTION OF THE DRAWINGS

FIG. 1 is a schematic block diagram of an organic light emitting display device according to an exemplary embodiment of the present invention.

FIG. 2 is an equivalent circuit diagram of a single pixel in the organic light emitting display device according to an exemplary embodiment of the present invention.

FIG. 3 is a drawing illustrating waveforms of abnormal reset signals.

FIG. 4 is a drawing illustrating restoration of reset signals having abnormal waveforms in the organic light emitting display device according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through one or more additional elements. In addition, unless explicitly described to the contrary, the word “comprise”, and variations such as “comprises” and “comprising”, will be understood to imply the inclusion of stated elements but not the exclusion of any other elements.

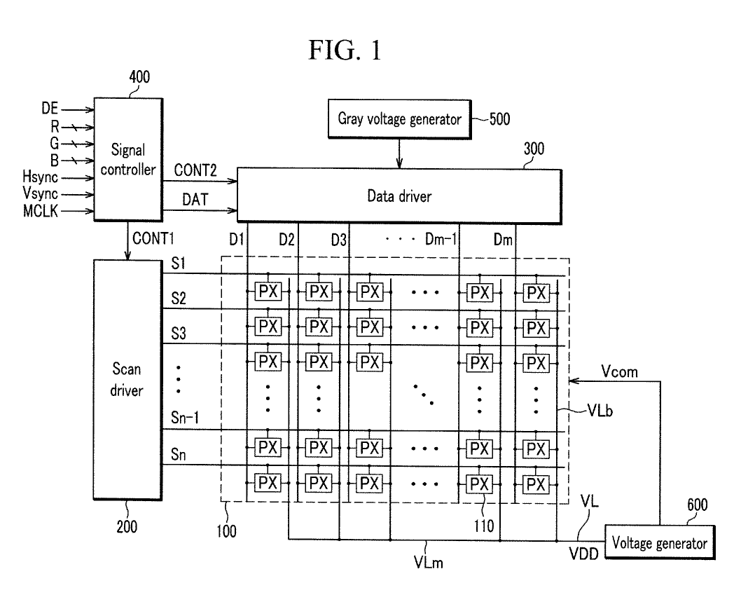

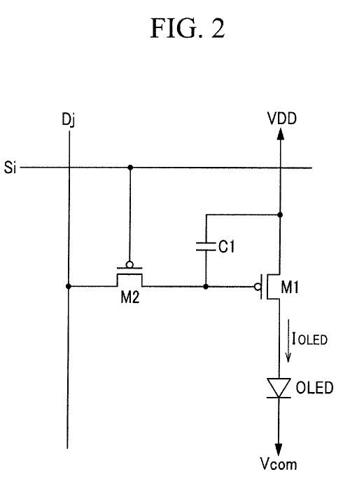

An organic light emitting display according to an exemplary embodiment of the present invention will now be described with reference to FIGS. 1 and 2.

FIG. 1 is a schematic block diagram of an organic light emitting display according to an exemplary embodiment of the present invention and FIG. 2 is an equivalent circuit diagram of a single pixel of the organic light emitting display according to an exemplary embodiment of the present invention.

As shown in FIG. 1, the organic light emitting display according to an exemplary embodiment of the present invention includes a display panel 100, a scan driver 200, a data driver 300, a gray voltage generator 500, a voltage generator 600, and a signal controller 400.

The display panel 100 includes a driving voltage line VL, a plurality of scan signal lines S1 through Sn, a plurality of data lines D1 through Dm, and a plurality of pixels PX respectively connected to the plurality of scan lines S1 through Sn and the plurality of data lines D1 through Dm and arranged in a matrix form.

A plurality of scan signals are respectively transmitted through the plurality of scan signal lines S1 through Sn and a plurality of data signals are respectively transmitted through the plurality of data lines D1 through Dm. The scan signals S1 through Sn extend in a row direction and are arranged in parallel, and the data lines D1 through Dm extended in a column direction and are also arranged in parallel.

The driving voltage line VL transmits a driving voltage VDD and includes a main line VLm and a plurality of branch lines VLb branching off from the main line VLm. The main line VLm extends in a row direction and the branch lines VLb extend in a column direction. Alternatively, the main line VLm may extend in the column direction and the branch lines VLb may extend in the row direction, or the main line VLm and the branch lines VIb can alternatively be arranged in various other configurations.

As shown in FIG. 2, a pixel PX, for example, a pixel PX connected to an i-th scan signal Sᵢ and a j-th data line Dⱼ, includes an organic light emitting diode (OLED), a driving transistor M1, a storage capacitor C1, and a switching transistor M2.

The switching transistor M2 includes a control terminal connected to the scan signal line S1, an input terminal connected to the data line Dⱼ, and an output terminal connected to the driving transistor M1. The switching transistor M2 transmits a data voltage applied to the data line Dⱼ in response to a scan signal applied to the scan signal line Sᵢ. A data signal of the organic light emitting display device according to an exemplary embodiment of the present invention is a voltage signal having a level depending on a gray level of a corresponding pixel PX. However, the present invention is not limited thereto.

The driving transistor M1 includes a control terminal connected to the switching transistor M2, an input terminal connected to a corresponding branch line VLb of the driving voltage line VL, and an output terminal. The driving transistor M1 receives a driving voltage VDD through the input terminal. The output terminal is connected to the OLED. The driving transistor M1 provides an output current I_{OLED} having a magnitude depending on a voltage difference between the control terminal and the input terminal.

The storage capacitor C1 is connected between the control terminal and the input terminal of the driving transistor M1. The storage capacitor C1 is charged with the data voltage and uniformly maintains a voltage difference corresponding to the data voltage. Therefore, a voltage difference between the control terminal and the input terminal of the driving transistor M1 is uniformly maintained even after the switching transistor M2 is turned off.

The OLED includes an anode connected to the output terminal of the driving transistor M1 and a cathode connected to a common voltage Vcom. The anode may be a pixel electrode (not shown) in a region partitioned by two adjacent scan lines and two adjacent data lines, and the cathode may be a part of a common electrode (not shown) on the front side of the display panel 100. The OLED emits light with intensity depending on the output current I_{OLED} of the driving transistor M1.

The OLED may emit light in one of three primary colors or light in one of the three primary colors and white. An example of the three primary colors includes red, green, and blue, and the three primary colors are spatially combined to obtain a desired color. Alternatively, OLEDs of all the pixels PX can emit white light, and some of the pixels PX can further include a color filter (not shown) that changes white light emitted from their OLEDs to light in one of the primary colors.

The switching transistor M2 and the driving transistor M1 are p-channel field effect transistors (FETs) formed of polysilicon in one embodiment. In some embodiments, at least one of the switching transistor M2 and the driving transistor M1 may be an n-channel FET. Furthermore, the connecting configuration between the driving transistor M1, the switching transistor M2, the capacitor C1, and the OLED may be modified.

Referring back to FIG. 1, the gray voltage generator 500 generates a plurality of reference gray voltages relating to luminance of the pixels PX. The number of reference gray voltages is smaller than the number of total gray levels.

The scan driver 200 is connected to the scan signals S1 through Sn of the display panel 100 and applies a scan signal of either a low voltage Von, which turns on the switching transistor M1, and a high voltage Voff, which turns off the switching transistor M1, to each of the scan signal lines S1 through Sn.

The data driver 300 is connected to the data lines D1 through Dm, divides the reference gray voltages received from the gray voltage generator 500 to generate data voltages and applies the data voltages to the data lines D1 through Dm.

The voltage generator 600 is connected to the driving voltage line VL of the display panel 100, generates the driving voltage VDD and applies the driving voltage VDD to the driving voltage line VL. Furthermore, the voltage generator 600 applies the common voltage Vcom to the display panel 100.

The signal controller 400 controls the scan driver 200, the data driver 300, and the gray voltage generator 500.

The driving devices 200, 300, 400, 500, and 600 may be integrated into the display panel 100 together with the signal lines S1 through Sn and D1 through Dm and the transistors M1 and M2. Alternatively, the driving devices 200, 300, 400, 500, and 600 may be directly mounted on the display panel 100 in the form of at least one integrated circuit chip, mounted on a flexible printed circuit film (not shown) and bonded to the display panel 100 in the form of a tape carrier package (TCP), or mounted on an additional printed circuit board (not shown). Furthermore, the driving devices 200, 300, 400, 500, and 600 may be integrated into a single chip and, in this case, at least one of the driving devices or at least one of the circuit elements constructing the driving devices may be located outside the single chip.

The operation of the organic light emitting display device will now be explained in detail.

When the display device is turned on, the display device is provided with power from an external power supply. When the display device is mounted in a mobile phone, the external power supply may be a battery of the mobile phone. That is, when the mobile phone is turned on, the power of the battery is applied to the display device. When the display device is applied to a monitor or a TV receiver, the display device provides power through a power line to the driving devices 200, 300, 400, 500, and 600. Here, the scan driver 200 and the data driver 300 that respectively apply scan signals and data signals to the display panel 100 generally receive a reset signal to initialize and begin operating after power is provided. The signal controller 400 applies the reset signal to the scan driver 200 and the data driver 300 when the display device is turned on. This process will be described later in more detail.

The signal controller 400 receives input video signals R, G, and B and an input control signal for controlling display of the input video signal from an external graphics controller (not shown). The input video signals include luminance information of each pixel PX, the luminance having a gray level within a gray level range, for example, 1024=2¹⁰, 256=2⁸, or 64=2⁶ gray levels. Examples of different input control signals include a vertical synchronization signal Vsync, a horizontal synchronization signal Hsync, a main clock signal MCLK, and a data enable signal DE.

The signal controller 400 appropriately processes the input video signals R, G, and B to generate an output video signal DAT on the basis of the input video signals R, G, and B and the input control signal, and to generate a scan control signal CONT1 and a data control signal CONT2. The signal controller 400 sends the scan control signal CONT1 to the gate driver 200 and transmits the data control signal CONT2 and the output video signal DAT to the data driver 300. Furthermore, the signal controller 400 initially transmits a reset signal RTS to the scan driver 200 and the data driver 300 and, when the reset signal is abnormal, restores the abnormal reset signal to a normal reset signal and then transmits the normal reset signal.

The scan control signal CONT1 includes a scan start signal STV that instructs scanning of the low voltage Von to be started and at least one clock signal that controls an output period of the low voltage Von. The scan control signal CONT1 may further include an output enable signal OE for restricting the duration of a gate on voltage, that is, the low voltage Von.

The data control signal CONT2 includes a horizontal synchronization start signal STH that indicates the start of transmission of the output video signal DAT for pixels PX corresponding to a single row, a load signal LOAD that instructs analog data voltages to be applied to the data lines D1 through Dm and a data clock signal HCLK.

The gray voltage generator 500 generates a reference gray voltage and provides the reference gray voltage to the data driver 300.

The data driver 300 starts to operate according to the reset signal RTS, receives output video data DAT for pixels corresponding to a single row according to the data control signal CONT2, divides the reference gray voltage to generate analog data voltages corresponding to the output video data DAT, and then applies the analog data voltages to corresponding data lines D1 through Dm.

The scan driver 200 also begins operating according to the reset signal RTS and converts scan signals applied to the scan signal lines S1 through Sn into the low voltage Von according to the scan control signal CONT1. Then, the switching transistors M2 connected to a corresponding scan signal line of the scan signal lines S1 through Sn are turned on, and data voltages applied to the data lines D1 through Dm are provided to the control terminals of the driving transistors M1 of the corresponding pixels PX.

The data voltage applied to each driving transistor M1 is charged in the storage capacitor C1 and the charged voltage is maintained when the switching transistor M2 is turned off. The driving transistor M1 provided with the data voltage is turned on to output the output current I_{OLED} having a magnitude corresponding to the data voltage. The OLED emits light with intensity depending on the magnitude of the output current I_{OLED} of the driving transistor M1, and thus a corresponding pixel PX displays an image.

After a lapse of one horizontal period (or “1H”) (one period of the horizontal synchronization signal Hsync and the data enable signal DE), the scan driver 200 and the data driver 300 repeat the aforementioned operation for pixels PX of the next row. In this manner, scan signals are applied to all the scan signal lines S1 through Sn for a single frame to supply data voltages to all of the plurality of pixels PX. When one frame is finished, the next frame is started and the same operation is repeated.

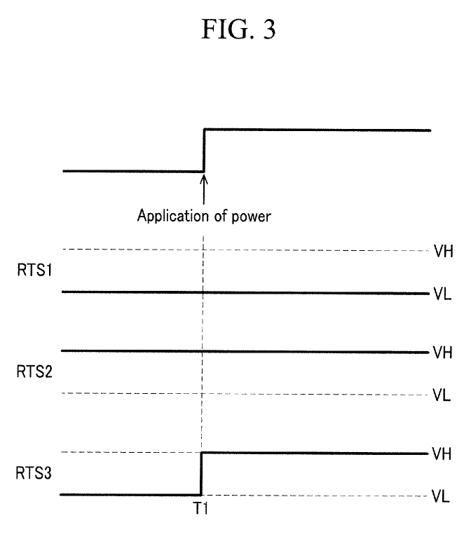

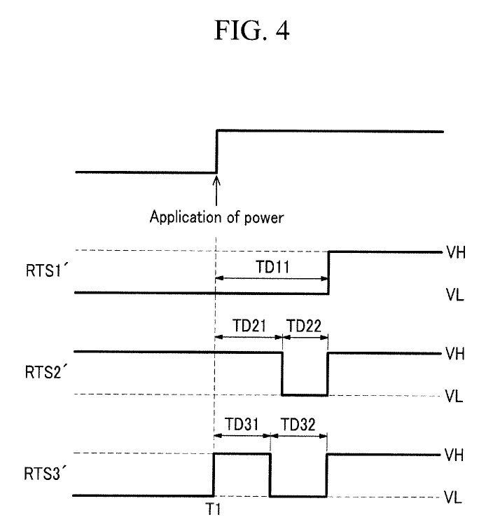

Restoration of a reset signal according to an exemplary embodiment of the present invention will now be described in detail with reference to FIGS. 3 and 4.

FIG. 3 is a drawing illustrating waveforms of abnormal reset signals.

When power is applied to the scan driver 200 and the data driver 300 at a time T1, a normal reset signal RTS has a waveform adjusted from a low level VL to a high level VH after the power is applied. Specifically, rising edge timing of the reset signal RTS is generated after the power is applied, and the scan driver 200 and the data driver 300 start to operate when they recognize the rising edge timing of the reset signal. However, reset signals RTS1, RTS2, and RTS3 illustrated in FIG. 3 do not have normal waveforms.

The reset signal RTS1 maintains a low level VL even after the time T1 at which the power is applied. Then, the scan driver 200 and the data driver 300 may not be properly started.

The reset signal RTS2 continuously maintains a high level VH, and thus the scan driver 200 and the data driver 300 may not recognize a time at which the power is adjusted from the low level VL to the high level VH. In this case also, the scan driver 200 and the data driver 300 may not be properly started.

A time at which the reset signal RTS3 is adjusted from a low level VL to a high level VH corresponds to the time T1, and thus the scan driver 200 and the data driver 300 cannot recognize the time.

The signal controller 400 detects a reset signal in synchronization with a time at which power is applied to the scan driver 200 and the data driver 300 for a period of time following application of power. The signal controller 400 determines whether the detected reset signal is normal. When a reset signal is abnormal, as illustrated in FIG. 3, the signal controller 400 restores the abnormal reset signal to a normal reset signal and transmits the restored normal reset signal to the scan driver 200 and the data driver 300.

FIG. 4 is a drawing illustrating reset signals restored from the reset signals RTS1, RTS2, and RTS 3 having abnormal waveforms illustrated in FIG. 3.

When a reset signal RTS1′ maintains the low level VL for a time TD11 even after the time T1, the signal controller 400 increases the reset signal RTS1′ to the high level VH and outputs the increased reset signal.

The signal controller 400 detects a reset signal RTS2′, which maintains the high level VH at the time T1, for a time TD21 after the time T1. When the level of the reset signal RTS2 is not varied for the time TD21, the signal controller 400 decreases the reset signal RTS2 to the low level VL, and then increases the reset signal RTS2 to the high level after a lapse of time TD22. Then, the reset signal RTS2′ has a waveform adjusted from the low level VL to the high level VH after the time T1. The time TD21 and the time TD22 can be appropriately set such that a rising edge timing at which the reset signal RTS2′ increases from the low level to the high level is generated.

The signal controller 400 decreases a reset signal RTS3′ to the low level after a lapse of time TD31 when a time at which the reset signal RTS3′ is adjusted from the low level to the high level corresponds to the time T1 or earlier, and then increases the reset signal RTS3′ after a predetermined lapse of time TD32. Then, the reset signal RTS3′ has a waveform adjusted from the low level VL to the high level VH after the time T1. The time TD31 and the time TD32 can be appropriately set such that a rising edge timing at which the reset signal RTS3′ increases from the low level to the high level is generated.

As described above, the signal controller 400 restores a reset signal and transmits the restored reset signal to the scan driver and the data driver, and thus the scan driver and the data driver may be normally started after power is applied.

While this invention has been described in connection with what is presently considered to be practical exemplary embodiments, it is to be understood that the invention is not limited to the disclosed embodiments, but is instead intended to cover various modifications and equivalent arrangements included within the spirit and scope of the appended claims.

What is claimed is:

1. A display device comprising:
a scan driver for transmitting scan signals to a plurality of scan lines;
a data driver for transmitting data signals to a plurality of data lines; and
a signal controller for controlling the transmissions of the scan driver and the data driver,
wherein the scan driver and the data driver are configured to begin operating in response to a reset signal, and wherein the signal controller is configured to detect the reset signal, to determine whether the detected reset signal is a normal reset signal or an abnormal reset signal applied after an on time at which power is supplied to the scan driver and the data driver, and to apply a normal reset signal when the detected reset signal is determined to be an abnormal reset signal.

2. The display device of claim 1, wherein the scan driver and the data driver are configured to begin operating when a voltage of the reset signal is adjusted from a first level to a second level after the on time.

3. The display device of claim 2, wherein the signal controller is configured to determine that the detected reset signal is an abnormal reset signal when the voltage of the detected reset signal corresponds to the first level at the on time and the voltage of the reset signal is not adjusted after the on time, and to apply a normal reset signal by adjusting the voltage of the reset signal to the second level.

4. The display device of claim 2, wherein the signal controller is configured to determine that the detected reset signal is an abnormal reset signal when the voltage of the detected reset signal corresponds to the second level at the on time, and to apply a normal reset signal by adjusting the voltage of the reset signal to the first level, and then adjusting the voltage of the reset signal back to the second level.

5. The display device of claim 2, wherein the signal controller is configured to determine that the detected reset signal is an abnormal reset signal when the voltage of the detected reset signal is adjusted from the first level to the second level at or before the on time, and to apply a normal reset signal by adjusting the voltage of the reset signal to the first level, and then adjusting the voltage of the reset signal back to the second level.

6. The display device of claim 2, wherein the first level corresponds to a low level and the second level corresponds to a high level.

7. The display device of claim 3, wherein the first level corresponds to a low level and the second level corresponds to a high level.

8. The display device of claim 4, wherein the first level corresponds to a low level and the second level corresponds to a high level.

9. The display device of claim 5, wherein the first level corresponds to a low level and the second level corresponds to a high level.

10. The display device of claim 1, further comprising:
a plurality of pixels arranged in a matrix, each of the plurality of pixels including a switching transistor and a driving transistor;
a driving voltage line for transmitting a driving voltage to the driving transistors of the plurality of pixels;
a voltage generator for applying the driving voltage to the driving voltage line; and
a gray voltage generator for generating a gray voltage,
wherein the data driver is configured to convert an input video signal to a data voltage in accordance with the gray voltage and to apply the data voltage to the data lines.

11. The display device of claim 10, wherein each of the plurality of pixels further comprises a capacitor coupled between an input terminal and a control terminal of the driving transistor, wherein the scan signals are transmitted to a control terminal of the switching transistor, and wherein an output terminal of the switching transistor is coupled to the control terminal of the driving transistor, an input terminal of the switching transistor is coupled to a corresponding one of the data lines, and an output terminal of the driving transistor is coupled to a light emitting element.

12. The display device of claim 11, wherein the light emitting element is an organic light emitting diode.

13. A method of driving a display device including at least one driver configured to begin operating after power is supplied in accordance with a reset signal, the method comprising:
detecting the reset signal;
determining whether the detected reset signal is a normal reset signal or an abnormal reset signal after the power is first supplied; and
applying a normal reset signal when the detected reset signal is determined to be an abnormal reset signal.

14. The method of claim 13, wherein a normal reset signal is detected when a voltage of the reset signal is adjusted from a first level to a second level after the power is first supplied.

15. The method of claim 14, wherein an abnormal reset signal is detected when the voltage of the reset signal corresponds to the first level when the power is first supplied and the voltage of the reset signal is not adjusted after the power is first supplied, and wherein applying a normal reset signal comprises adjusting the voltage of the reset signal to the second level.

16. The method of claim 14, wherein an abnormal reset signal is detected when the voltage of the reset signal corresponds to the second level when the power is first supplied, and wherein applying a normal reset signal comprises adjusting the voltage of the reset signal to the first level, and then adjusting the voltage of the reset signal back to the second level.

17. The method of claim 14, wherein an abnormal reset signal is detected when the voltage of the reset signal is adjusted from the first level to the second level at or before a time when the power is first supplied, and wherein applying a normal reset signal comprises adjusting the voltage of the reset signal to the first level, and then adjusting the voltage of the reset signal back to the second level.
